(19) United States
(12) Patent Application Publication
(10) Pub. No.: US 2002/0135091 A1
(43) Pub. Date: Sep. 26, 2002

(54) Female mold for plastic sanitaryware

(76) Inventors: Hiram Rivera, Valdosta, GA (US); Dan Spiecher, Valdosta, GA (US)

Correspondence Address: John P. Sinnott, Langdale, Vallotton, et. al., P.O. Box 1547, Valdosta, GA, 31603, US

(21) Appl. No.: 09/767,315

(22) Filed: Jan. 22, 2001

(51) Int. Cl. B29C 33/40; B29C 33/60; B29C 39/12

(52) U.S. Cl. 264/102; 264/69; 264/219; 264/265; 264/338; 425/346; 425/394; 249/114.1

(57) ABSTRACT

A female mold for plastic sanitaryware manufacture has an open top to promote improved air escape from the mold as resinous backing resin fills the mold in order to reduce the number of gas inclusions within the backing material after it is cured. The female mold also provides thermal insulation for the curing backing material to permit better curing and to reduce the potential for delamination in the finished product. A production fixture is equipped with a gas impermeable lid for selective contact with the female mold, after the air has been expelled from the mold, in order to control undesirable styrene emissions.

### FIELD OF THE INVENTION

This invention relates to plastic molding apparatus and, more particularly, to a female mold structure for use in manufacturing items of plastic sanitaryware, and the like.

### BACKGROUND OF THE INVENTION

The advantages of plastic sanitaryware, e.g., lavatories, bathtubs, shower stalls, and shower trays, in contrast with the ceramic and enamel-on-cast iron or enamel-on-steel units that characterized the prior art are well known. Illustratively, plastic sanitaryware is much lighter than corresponding pieces of ceramic or enamel ware. Consequently, less labor and effort is needed to install plastic ware fixtures either as replacements in existing bathrooms or in new construction. Further in this regard, although an item of plastic sanitaryware is considerably lighter than an enamel or ceramic counterpart, plastic sanitaryware, when properly made with a heavy backing material for the plastic surface structure, or shell, has a “solid feel” to it; that is, a stable and sound response to application of body pressures. In this manner, well made plastic sanitaryware is able to overcome the flimsy and “cheap” reputation that some plastic sanitaryware units constructed without a suitably heavy backing structure acquired because of the unsupported and undamped resilient response of these less sturdy units to body weight application.

There are a number of other advantages inherent in the use of plastic sanitaryware in contrast, particularly, with enamel fixtures. For example, if during construction, a heavy weight, such as a hammer or other tool, is dropped on an enamel ware unit, the enamel will almost always chip or crack, requiring a costly replacement of the entire fixture. Dropping the same heavy weight on a plastic fixture, however, might not mar the fixture or, even if marring does occur, the marred surface can be repaired by buffing to restore the surface to an undamaged condition.

Manufacturing suitable plastic sanitaryware, however, has led to several difficult production problems. Illustratively, a typical item of plastic sanitaryware is manufactured by first forming an acrylic plastic shell in the general shape of the final product. The non-finish side of the acrylic shell is suitably activated in order to bond with a resin that is manually sprayed or brushed onto the non-finish side. The foregoing procedure is slow, involves a considerable amount of manual labor and produces products that vary widely in quality.

The resin, moreover, often spills out from the non-finish side of the acrylic shell to which it is applied. The waste in material and extra labor required to trim off the spilled resin from the finished piece is quite clear. Premature cooling of the setting resin creates further difficulties. For example, if a thermosetting resin cools too quickly, the resulting product will be of poor quality and subject to delamination or other undesirable consequences.

In those instances in which an acrylic shell has been lodged in a female mold, it had been customary to close or to put a perforated lid on the otherwise open back of the mold. As a result, the acrylic shell is seated in one side of the female mold and the side of the mold that is opposite to the shell is obstructed by a solid or a perforated lid. Flowing a backing resin into the void space within the female mold, however, leads to air entrapment within the resinous backing material in spite of the perforations in some of the lids that have been used with these older female molds. Air trapped within the female mold's void space can not be expelled completely from the mold as the resin flows into the female mold. Thus, the trapped air often forms bubbles within the backing material when the resin cures, or become hardened. This hardening of the resin and bubble formation is aggravated by a premature heat loss from the curing resin. Had the heat of the curing resin been conserved, not only would a better resinous backing material be produced, but also the curing resin would have remained fluid long enough to enable more air to escape, thereby at least reducing bubble formation.

As a result there is a need for an improved female mold structure that will conserve the heat within a curing backing resin to produce a better product and a structure that will permit air to escape more readily from the mold as the resin flowing into the mold displaces the air within the mold void space.

There is a further and more subtle need that a female mold structure should satisfy. Curing resins produce environmentally undesirable styrene emissions. These emissions must be controlled in order to establish an environmentally acceptable manufacturing process.

### SUMMARY OF THE INVENTION

These and other needs that have characterized the prior art are satisfied to a large extent through the practice of the invention. For example, a salient feature of a female mold that embodies principles of the invention is the addition of thermal insulation to the female mold structure. This insulation arrests the escape of heat from the thermosetting resin within the mold. In this manner, the mold promotes better curing for the resin, thereby producing a consistently superior product that is less subject to defects, such as delamination, than prior art mold structures.

A further salient feature of the invention is embodied in the manner in which air is allowed to escape from the female mold as that mold is being filled with curing resin. Thus, a pair of acrylic shells, vacuum molded in the shape of a sanitaryware fixture is mounted in a production fixture with the non-finished side of the pair of shells each facing respective female molds. The two female molds, moreover, are both mounted on a movable stage, each of these molds being in vertical alignment with a respective one of the molded acrylic shells. These female molds are provided with vertical sides and an open top.

A set of pneumatic cylinders control the vertical movement of the stage to selectively lower the female molds into position around their associated shells.

When the female molds are lowered into position relative to the respective shells they form liquid-tight seals between the acrylic flange surrounding each of the shells and the corresponding contacting edge of the sides that form the mold. A catalyzed resin is pumped into each of the female molds in order to bond to the non-finished sides of the acrylic shells. The catalyzed resin, being a thermosetting substance, generates heat while curing and, as the resin is being pumped or poured into the individual female molds, displaces the air in these molds, the air escaping to the atmosphere through the open tops of the molds.

As the resin is curing, and after the air within the molds has been fully displaced, a pair of lids, mounted on the production frame by means of pneumatic cylinders, are pressed downwardly to bear against the upper edges of the respective female molds. These lids, when positioned on their molds, form an essentially gas-tight seal with the respective molds. This seal prevents environmentally undesirable styrene fumes from the curing resin from escaping into the atmosphere, which is a significant improvement over prior art processes.

Thus, there is provided in accordance with the invention an improved female mold and method for using that mold to produce quality sanitaryware in contrast with that which has characterized the prior art, the scope of the invention, however, is limited only through the claims appended hereto.

### BRIEF DESCRIPTION OF THE DRAWING

FIG. 1 is a perspective view of a typical vacuum formed sanitaryware shell for use in connection with the invention;

FIG. 2 is a perspective view of a female mold for use with the shell shown in FIG. 1, embodying features of the invention;

FIG. 3 is a perspective view of a production fixture for use with the shell and mold shown in FIGS. 1 and 2 that illustrate further salient features of the invention;

FIG. 4 is a full section view of a portion of a female mold for use in accordance with the invention; and

FIG. 5 is a full side elevation in full section of a portion of a sanitaryware item made through the apparatus shown in FIGS. 1 through 5.

### DETAILED DESCRIPTION

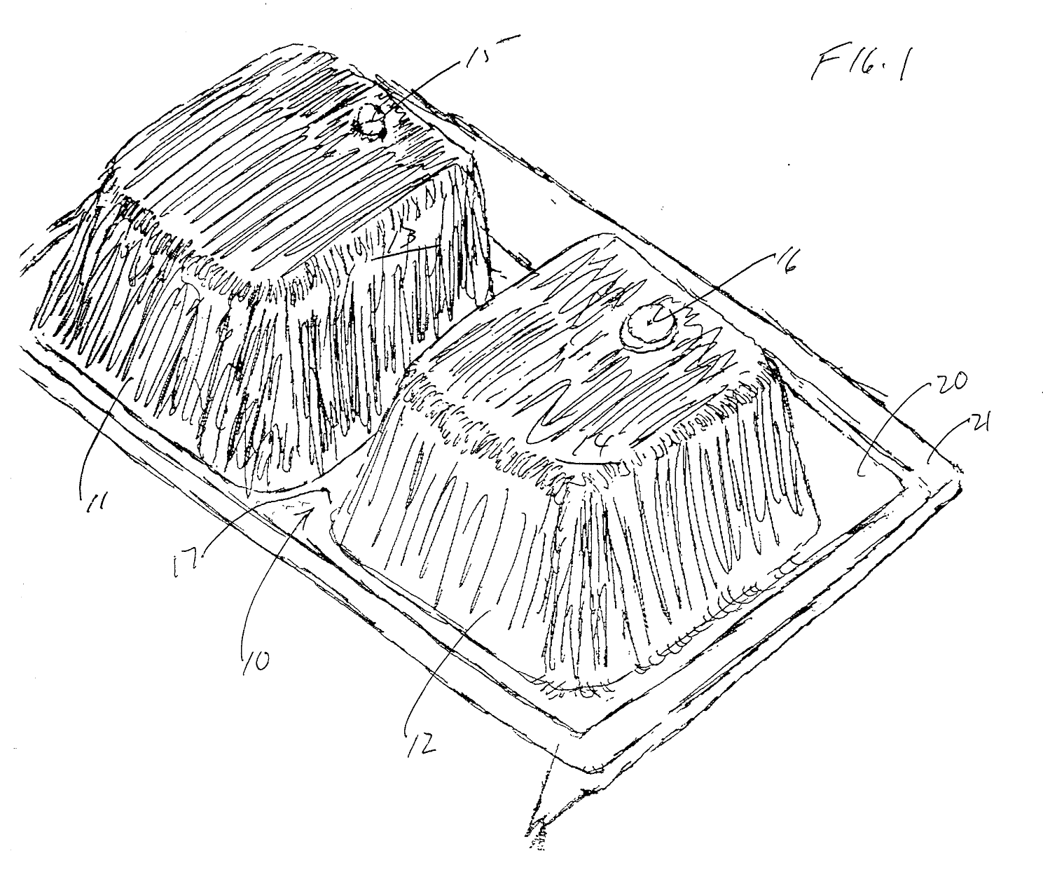

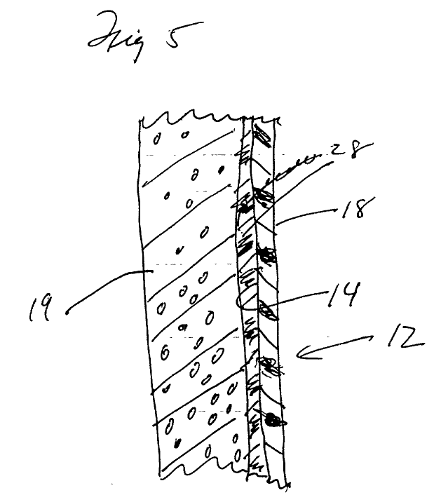

For a more complete appreciation of the invention, attention is invited to FIG. 1 which shows an acrylic shell 10 in which two lavatory shells 11, 12 have been vacuum molded. The shell 10 has two primary surfaces, a finished side 18 (FIG. 5) that will constitute the exposed surface of the lavatory shells 11, 12 in the completed sanitaryware fixture. Illustrated in FIG. 1 of the drawing, however, are unfinished surfaces 13, 14 of the respective lavatory shells 11, 12 that are opposite to the finished surface of which only the finished surface 18 (FIG. 5) is shown in the drawing. Each of the lavatory shells 11, 12 (FIG. 1), moreover, is provided with individual drain holes 15, 16, respectively, for the purpose of enabling waste water to drain from the fixtures, when these fixtures are completed and installed.

The two lavatory shells 11, 12 are joined together by means of a web 17 that facilitates handling of the acrylic shell 10 because as joined at the web 17, both of the lavatory shells 11, 12 can be processed as a single unit until final finishing and trimming, as described subsequently in more complete detail.

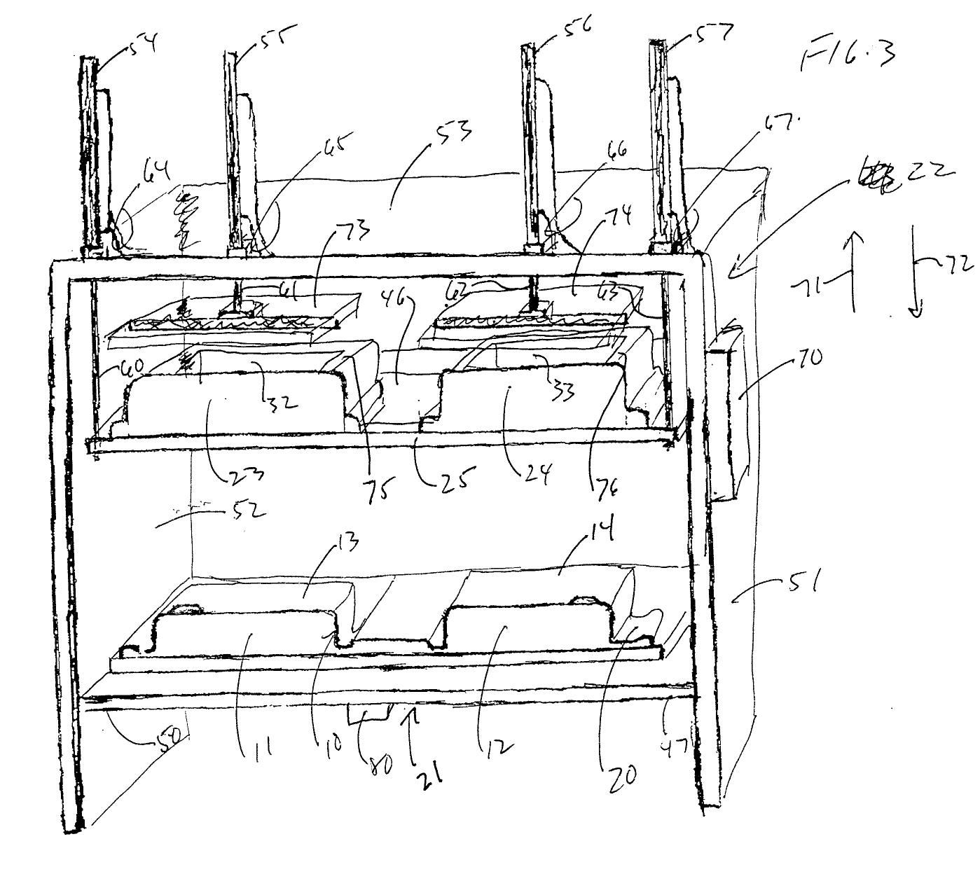

The acrylic shell 10 also has a peripheral flange 20 that rests on a horizontally disposed base 21 for a production fixture 22 (FIG. 3).

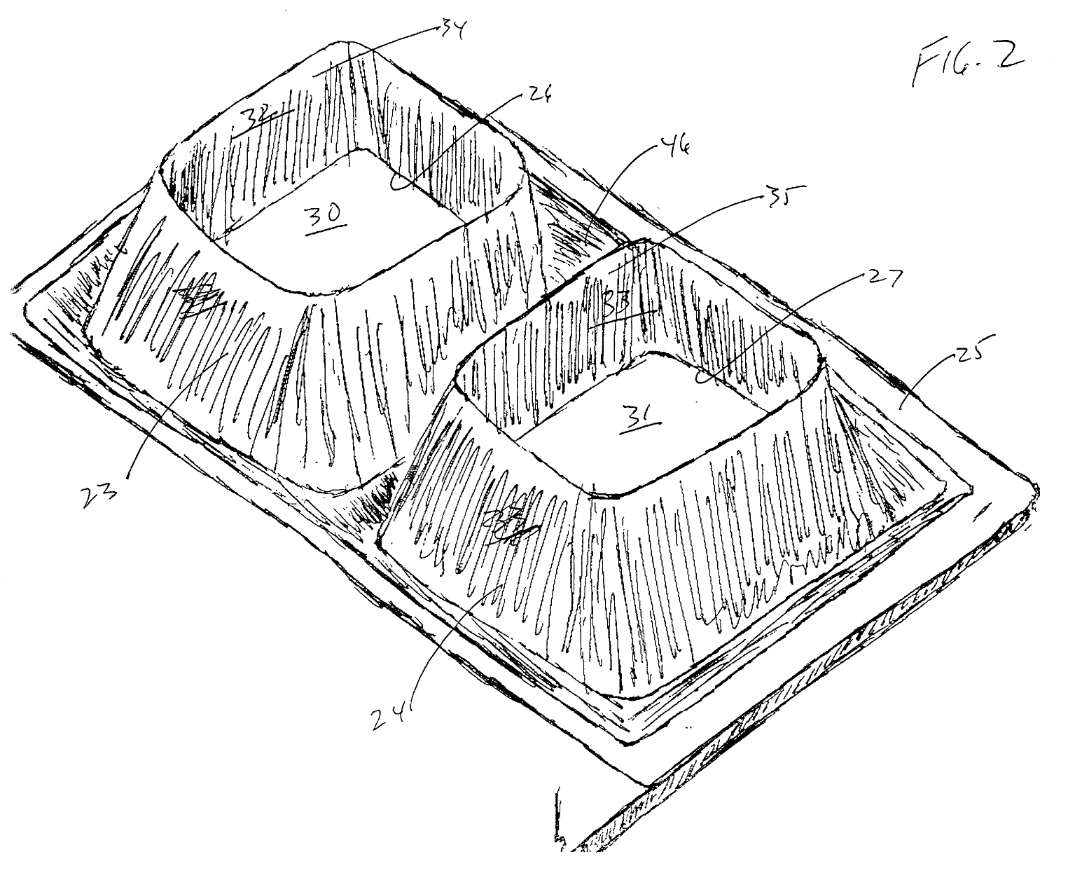

Turning now to FIG. 2, two female molds 23, 24 are shown on a vertically movable stage 25. The stage 25 has apertures 26, 27 that are aligned with corresponding openings 30, 31 in the respective molds 23, 24. Mold wall or walls 32, 33, generally perpendicular to the plane of the stage 25 have inner surfaces 34, 35 that define the dimensions of the perimeters of the respective openings 30, 31. These dimensions are adequate to encompass the lavatory shells 11, 12 (FIG. 1) within the confines of the respective inner surfaces 34, 35 (FIG. 2) of the female molds 23, 24 and to provide gaps between the unfinished surfaces 13, 14 of the lavatory shells 11, 12 and the inner surfaces 34, 35 of the female molds 23, 24 to enable a suitably thick layer of resinous backing material 19 (FIG. 5) to form between the unfinished surfaces 13, 14 of the lavatory shells 11, 12 and the inner surfaces 34, 35 of the female molds 23, 24.

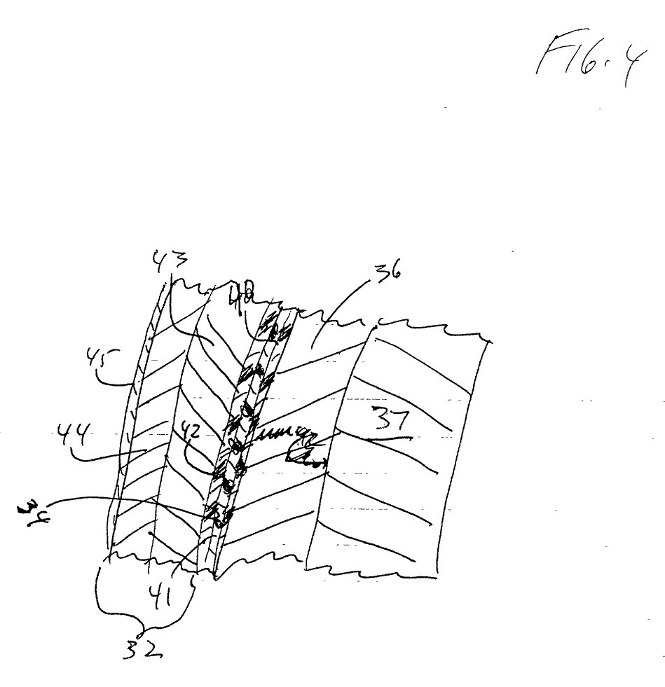

To prepare a female mold, wood 36 (FIG. 4), preferably balsa wood, is applied to the outside of the male mold 37, the thickness of the wood 36 establishing a predetermined gap between the male mold and the inner surfaces 34, 35 (FIG. 2) of the female molds 23, 24 that are under construction. This gap is equal to the desired thickness of the resinous backing material 19 (FIG. 5).

Primer 40 (FIG. 4) is sprayed on exposed surface of the wood. The primed wood then is sanded to 150 grit with wax and polyvinyl alcohol (PVA) 41 being applied subsequently to the primed and sanded wooden surface.

In accordance with a feature of the invention, a tooling lubricant, preferably Gelcoat 42, is sprayed onto the prepared wax 41 on the sanded and waxed surface of the wood 36 mounted on the male mold 37. The Gelcoat 42 is sprayed to a desired thickness and dried to the touch before a mixture of polyester resin and fiberglass 43 is sprayed into place on the Gelcoat 42. Finally, balsa wood 44 is placed and sprayed with an adhesive 45 to the cured, exposed surface of the polyester resin and fiberglass mixture 43.

The cured and layered structure of polyester resin and fiberglass 43 to which the balsa wood 44 is joined through the adhesive 45, then is ground and demolded. A gasket 46 (FIG. 2), moreover, is glued to the perimeters of the respective female molds 23, 24, the dimensions of the gasket 46 being essentially the same as the corresponding dimensions of the web 17 (FIG. 1) and peripheral flange 20 of the acrylic shell 10.

To complete the female mold structure, a layer of Teflon, nickel plate, ceramic finish or stainless steel (not shown in the drawing) is secured to the inner surface 34 (FIG. 4) of the illustrative mold wall 32 (FIG. 2).

The female molds 23, 24 (FIG. 3), treated in the foregoing manner, are waxed and then mounted on the vertically movable stage 25 in the production fixture 22. In this way, the female molds 23, 24 conserve heat generated through exothermic reactions in the catalyzed resin 19 (FIG. 5) that is deposited within the mold walls 32, 33 (FIG. 2) for adherence to the unfinished surfaces 13, 14 of the lavatory shells 11, 12. Thus, the layered structure of the mold wall 32 shown in FIG. 4, a layered combination of Teflon, nickel plate or stainless steel, the resin and fiberglass mixture 43, completely covered with the layer of balsa wood 44 and the adhesive 45 provide an improved, more effective thermal insulation that enables the catalyzed and curing resin 19 (FIG. 5) within the female molds 23, 24 (FIG. 3) to harden in a manner that promotes better adherence between the unfinished surfaces 13, 14 of the lavatory shells 11, 12 and the cured resin 19 (FIG. 5). Finished product quality is improved and occurrences of delamination between the cured resin and the unfinished surfaces 13, 14 of the lavatory shells 11, 12 is significantly reduced.

As mentioned above, and best shown in FIG. 3, the peripheral flange 20 of the acrylic shell 10 is mounted horizontally on a stationary base 21 that is joined, at longitudinal ends 47, 50 to respective, fixed vertical supports 51, 52. The tops of the vertical supports 51, 52, moreover, are joined to a horizontal support 53.

Four actuators, or pneumatic cylinders 54, 55, 56, 57 are secured to the upper surface of the horizontal support 53 to enable respective piston rods 60, 61, 62, 63 to protrude vertically through the horizontal support 53 for individual and selective vertical movement. Each of the pneumatic cylinders 54, 55, 56, 57 has a respective control element 64, 65, 66, 67 connected to a control panel 70 that is secured to the outer surface of the vertical support 51. The control panel enables the piston rods 60 and 63 to be moved simultaneously and through the same distances in vertically upward and downward directions, as illustrated by means of arrows 71, 72. The pneumatic cylinders 55, 56, however, and in accordance with another salient feature of the invention, are each separately operable through the control panel 70 to move individually in the directions of the arrows 71, 72 as described subsequently, in more complete detail.

To complete the description of the production fixture 22, it should be noted that the free ends of the piston rods 60, 63 are connected to the movable stage 25 for selective vertical movement in the directions of the arrows 71, 72 under the control of the respective pneumatic cylinders 54, 57 with which the piston rods 60, 63 are associated. As described above, the gasket 46 is mounted, in fluid-tight relation, on the movable stage 25, the mold walls in the female molds 23, 24 being aligned with the individual openings 30, 31 (FIG. 2) in the movable stage 25.

Two flat, horizontally arranged lids 73, 74, spaced below the horizontal support 53 are connected, individually, to piston rods 61, 62, respectively. In accordance with the invention, the lids 73, 74 are separately movable in the vertical directions of the arrows 71, 72 under control from the panel 70. The range of motion for the lids 73, 74 is defined by the gap between the inner and lower surface of the horizontal support 53 and corresponding top edges 75, 76 of the female molds 23, 24.

In operation, the unfinished surfaces 13, 14 of the lavatory shells 11, 12 are activated by automatically or otherwise spraying a barrier coat 28 (FIG. 5) on the unfinished surfaces 13, 14. Illustratively, a typical barrier coat 28 can have the following composition:

Acrylic Barrier Coat

| Resin Mix | | Product | Weight per | Weight Per | % |
|---|---|---|---|---|---|
| Component | Supplier | Code | U.S. Gallon | Recipe (lbs.) | Recipe |
| Resin | Hydrex | 33348-15 | 10.5 | 237.5 | 59.26% |
| Filler | Performance Minerals | SPT | N/A | 100 | 24.95% |
| | Dancing Bear Minerals | PDT-325 | N/A | | |
| Gelcoat | Neste | WG-2X1984 | 10.8 | 35 | 8.73% |
| | Interplastics | W-663B-IUU | | | |
| Pigment | American Colors | PC-47173 | 19.9 | 19 | 4.74% |
| Cabosil | Composite One | 20913 | N/A | 3 | 0.75% |
| Catalyst | Norac | 925 | 8.0 | 5.92278 | 1.48% |
| 6% Cobalt | Composite One | 23820-MG | 7.0 | 0.352 | 0.09% |

For the purpose of this illustrative example, about five to seven pounds of barrier coat material should be sprayed on each of the lavatory shells 11, 12 in order to properly bond the barrier coat not only to the unfinished surfaces 13, 14 of the lavatory shells 11, 12 but also to bond the barrier coat to the subsequently applied catalyzed resin and fiberglass mixture 19 (FIG. 5) that constitutes the backing material for the finished product.

The pneumatic cylinders 54, 57 are activated to draw the stage 25 upward until the stage 25 reaches about two-thirds of the height of the vertical supports 51, 52 from the bottom of these supports 51, 52.

The female molds 23, 24 are cleaned and waxed with TR 214 mold release wax. Then, the female molds 23, 24 are placed on the vertically movable stage 25 in alignment with respective openings 30, 31 (FIG. 2) in the stage 25. The gasket 46 (FIG. 3), moreover, forms a fluid-tight seal between the stage 25 and the female molds 23, 24. The pneumatic cylinders 54, 57 next are activated to lower the stage 25 downwardly in the direction of the arrow 72 to permit the stage 25 to settle firmly on the peripheral flange 20, establishing a fluid-tight seal with the flange 20.

Because the openings 30, 31 in the stage 25 also are aligned with corresponding lavatory shells 11, 12, the shells 11, 12 are nested within their associated female molds 23, 24 with a clearance between the mold walls 32, 33 and the opposite unfinished surfaces 12, 13 of the lavatory shells 11, 12 to accommodate a predetermined thickness of the backing material 19 (FIG. 5).

A typical resin mix for the backing 19 on the lavatory shells 11, 12 is:

Resin Mix

| Resin Mix | | Product | Weight per | Weight Per | % |
|---|---|---|---|---|---|
| Component | Supplier | Code | U.S. Gallon | Recipe (lbs.) | Recipe |
| Resin | Reichhold | 33348-15 | 1.8 | 19 | 35.31% |
| | Reichhold | 32144-08 | | | |
| | Interplastics | COR44-201-034 | | | |
| Filler | Performance Minerals | SPT | N/A | 33.5 | 62.25% |
| | Dancing Bear Minerals | PDT-325 | N/A | | |
| Pigment | American Colors | PC-47173 | 10.7 | 0.15625 | 0.29% |
| Glass | Owens Corning | 360-RR | N/A | 0.5 | 0.93% |
| Catalyst | NORAC | 925 | 8.0 | 0.66 | 1.23% |
| | NORAC | 9H | | | |
| | Reichhold | 46771 | | | |

This catalyzed resin mixture is poured either manually or through an automated delivery system into the female molds 23, 24 to fill the volume between the barrier coat on the lavatory shells 11, 12 and the corresponding mold walls 32, 33. A vibrator 80 attached to the fame 21 agitate the mold and shell structure as the backing resin is pouring into the molds. The vibrations fill the cavity in the mold more swiftly and promote escape of trapped air. The vibrator 80 can be applied to the molding apparatus and resin at any suitable place beside that shown on FIG. 3.

Other salient features of the invention are characterized not only by the open tops to the female molds 23, 24, but also by the fluid-tight seals between the gasket 46 on the female molds 23, 24 and the stage 25 with the peripheral flange 20. Thus, as the catalyzed resin 19 (FIG. 5) is flowing into the respective female molds 23, 24 (FIG. 3), the air within the molds 23, 24 is displaced by the resin, the air so displaced being ejected from the female molds 23, 24 through the open tops of these molds that are defined by the mold walls 32, 33. In this manner, air does not become trapped within the backing resin 19 (FIG. 5) to form quality-degrading bubbles and void spaces in the hardened resin. Because the heat from the exothermic curing of the resin 19 is conserved by the structure of the molds 23, 24 (FIGS. 3 and 4), the curing resin also maintains a degree of fluidity for a period somewhat longer than that which has characterized the prior art, thereby permitting the escape of even more air displaced by or entrained within the resin.

The tight seals that are established between the female molds 23, 24 and the peripheral flange 20 also reflect a further improvement that characterizes the invention. By establishing fluid-tight sealing, the catalyzed resin 19 (FIG. 5) within the female molds 23, 24 does not leak beyond the confines of the seals. In this way, expensive resin is not wasted and the labor that heretofore had been required to trim this excess resin from the finished product is no longer required.

With the aid of the thermally insulated female molds 23, 24, the curing resin within the molds reaches a temperature of 150° F. to 200° F. and, after a setting time of approximately twenty to thirty minutes, the resin is 95% cured.

The curing resin 19 in the female molds 23, 24 emits environmentally unacceptable styrene fumes. To prevent the dispersion of these fumes into the atmosphere, after suitable volumes of the resinous backing material 19 have been deposited in the molds 23, 24 and air, entrained within the resin 19 has been allowed to escape in the manner described above, the pneumatic cylinders 55, 56 are activated to lower the respective lids 73, 74 in the direction of the arrow 72, onto the top edges 75, 76, of the female molds 23, 24 to establish therewith an air tight relation. Styrene fumes emanating from the curing resin 19 within the molds 23, 24 are thus trapped within the void space (not shown in the drawing) between the resin 19, the exposed mold walls 32, 33 and the respective lids 73, 74. The styrene fumes, so trapped, can be off-gassed through a vacuum system (also not shown in the drawing) and stored safely for later, suitable disposal.

After off-gassing is complete, the pneumatic cylinders 55, 56 are once more energized to retract the lids 73, 74 in the upward direction of the arrow 71, clear of the molds 23, 24, as shown in FIG. 3.

Upon curing in the foregoing manner, the pneumatic cylinders 54, 57 are activated to draw the female molds 23, 24 upwardly in the direction of the arrow 71 to demold the lavatory shells 11, 12 and their associated cured resin backing 19 (FIG. 5) The stage 25 (FIG. 3) is drawn upwardly in the direction of the arrow 71 until a vertical clearance of 8 inches to 10 inches is established between the stage 25 and the demolded lavatory shells 11, 12 with their respective cured resin backings.

The lavatories then are removed from the production fixture 22 for drilling and trimming, as necessary, the approximate weight of a finished lavatory being about 56 pounds.

Thus, there is provided in accordance with the principles of the invention an improved method and production apparatus for manufacturing plastic sanitaryware from which bubbles and air inclusions within the backing material are markedly reduced and better curing and attendant improved bonding is attained between the backing material and the shell, while suppressing the emission of environmentally undesirable styrene fumes.

What is claimed is:

1. A process for manufacturing plastic sanitaryware having a shell and resinous backing material comprising the steps of mounting the shell in a production fixture, the shell having finished and unfinished surfaces, aligning a female mold with the shell, said mold having a wall that is spaced from said unfinished surface of the shell a distance equal to a predetermined thickness of the shell and the resinous backing material, said mold wall defining an opening there between, activating said unfinished surface of the shell to bond the shell to the resinous backing material, depositing the resinous backing material within said female mold to fill said space between said female mold wall and said activated unfinished surface of the shell, discharging air from said female mold through said mold opening to reduce porosity within the resinous backing material and suppressing styrene emission from the resinous backing material.

2. A process according to claim 1 further comprising the step of insulating said female mold in order to cure the resinous backing material more completely.

3. A process according to claim 1 further comprising the step of placing a lid over said mold opening in order to suppress said styrene emissions.

4. A process according to claim 1 comprising the further steps of spacing said female mold vertically above the shell, and lowering said female mold to the shell in order to establish said space between said unfinished surface of the shell and said female mold wall.

5. A process according to claim 1 further comprising the step of vibrating the resinous backing material to promote resin flow and dissipate entrapped air.

6. A process according to claim 4 further comprising the step of pouring the resinous backing material into said space between said female mold wall and said unfinished surface of the shell.

7. A process according to claim 4 further comprising the step of pumping the resinous backing material into said space between said female mold wall and said unfinished surface of the shell.

8. A process for manufacturing a female mold for engagement with a plastic shell in the shape of an item of sanitaryware comprising the steps of forming the interior surface of a layer of wood, in the shape of the item of sanitaryware, applying a primer to said layer of wood, depositing a layer of wax on said primer, coating said wax layer with a tooling lubricant, establishing a predetermined thickness for said layers of wood, primer, wax and tooling lubricant, depositing a mixture of polyester resin and fiberglass on said tooling lubricant, placing another wooden layer on the surface of said polyester resin and fiberglass, applying an adhesive to said another wooden layer to join said another wooden layer to said polyester resin and fiberglass, and demolding said another wooden layer and said polyester resin and fiberglass from said layers of wood, primer, wax and tooling lubricant whereby said another wooden layer, adhesive, polyester resin and fiberglass forms the female mold.

9. A process according to claim 7 further comprising the step of adding a layer to the female mold chosen from the group of Teflon, nickel plate, ceramic finish and stainless steel.

10. A female mold for manufacturing an item of plastic sanitaryware having a shell in the shape of the sanitaryware item comprising a layer of polyester resin and fiberglass having inner and outer surfaces, said inner surface establishing a predetermined separation between the female mold and the plastic shell, a layer of wood adhered to said polyester resin and fiberglass layer and a further layer chosen from the group of Teflon, nickel plate, ceramic finish or stainless steel.

11. A female mold according to claim 9 further comprising balsa wood in said layer of wood.

12. A female mold according to claim 9 further comprising a gasket on the perimeter of the female mold.

13. A production fixture for manufacturing plastic sanitaryware having a shell with an unfinished surface comprising a pair of spaced supports having respective ends, a base having means for mounting the shell thereon, said base being between said supports and proximate to said support ends, a further support spaced from said base, a first pair of actuators, each of said actuators being mounted on said further support for selective individual reciprocating movement toward and away from said base, a stage disposed between said supports for movement toward and away from said base, said stage having at least one opening formed therein in alignment with said shell mounting means, a second pair of actuators each of said second actuator pair being mounted on said further support and coupled to said stage for movement of said stage toward and away from said base, and a pair of gas impermeable lids, each of said lids coupled to a respective one of said actuators in said first actuator pair for selective individual movement toward and away from said stage.

14. A production fixture according to claim 13 further comprising a vibrator coupled to the fixture for vibrating at least a portion of the production fixture.
